(19) United States
(12) Patent Application Publication
(10) Pub. No.: US 2024/0249134 A1
(43) Pub. Date: Jul. 25, 2024

(54) CHARACTERIZING COMPUTER INFRASTRUCTURE USING MACHINE LEARNING TECHNIQUES

(71) Applicant: Dell Products L.P., Round Rock, TX (US)

(72) Inventors: Deborah C. Russell, Arvada, CO (US); Muzhar S. Khokhar, Shrewsbury, MA (US); Claudia Realegeno, Maple Valley, WA (US); Nikhil Manohar Vichare, Austin, TX (US)

(21) Appl. No.: 18/099,586

(22) Filed: Jan. 20, 2023

(51) Int. Cl. G06N 3/08; G06N 3/044

(52) U.S. Cl. CPC G06N 3/08; G06N 3/044

(57) ABSTRACT

Methods, apparatus, and processor-readable storage media for characterizing computer infrastructure using machine learning techniques are provided herein. An example computer-implemented method includes obtaining a machine learning model that is trained, using a set of training data, to generate one or more labels for one or more of a plurality of computer infrastructure elements, where the training data is based on information corresponding to user interactions and configuration information associated with at least a portion of the computer infrastructure elements; generating, using the machine learning model, at least one additional label for at least one additional computer infrastructure element using information corresponding to one or more user interactions and configuration information associated with the at least one additional computer infrastructure element; and performing one or more automated actions related to the at least one additional computer infrastructure element based at least in part on the at least one additional label.

### FIELD

The field relates generally to information processing systems, and more particularly to characterizing computer infrastructure associated with such systems.

### BACKGROUND

Computer infrastructure, such as hardware and/or software infrastructure, must often be tracked and/or maintained to improve security, usability, efficiency and/or availability of such computer infrastructure. To make this easier, some systems allow administrators to manually group data records associated with such computer infrastructure; however, this can be time-consuming and can also lead to inconsistencies regarding how a particular computer infrastructure element is assigned to a given group.

### SUMMARY

Illustrative embodiments of the disclosure provide techniques for characterizing computer infrastructure using machine learning techniques. An exemplary computer-implemented method includes obtaining at least one machine learning model, wherein the at least one machine learning model is trained, using a set of training data, to generate one or more labels for one or more of a plurality of computer infrastructure elements, and wherein the training data is based at least in part on information corresponding to one or more user interactions with at least a portion of the plurality of computer infrastructure elements and configuration information associated with at least a portion of the plurality of computer infrastructure elements; generating, using the at least one machine learning model, at least one additional label for at least one additional computer infrastructure element using information corresponding to one or more user interactions with the at least one additional computer infrastructure element and configuration information associated with the at least one additional computer infrastructure element; and performing one or more automated actions related to the at least one additional computer infrastructure element based at least in part on the at least one additional label.

Illustrative embodiments can provide significant advantages relative to conventional computer infrastructure characterization techniques. For example, technical problems associated with monitoring and maintaining computer infrastructure are mitigated in one or more embodiments by implementing a machine learning framework that can generate labels based on information associated with user interactions and configuration data corresponding to computer infrastructure elements, and then perform automated actions related to at least a portion of the computer infrastructure elements based on the labels.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for characterizing computer infrastructure using machine learning techniques in an illustrative embodiment.

FIG. 2 shows a flow diagram for training a machine learning model in an illustrative embodiment.

FIG. 3A shows an example of a classification notification in an illustrative embodiment, and FIG. 3B shows an example of a label selection interface in an illustrative embodiment.

FIG. 4 shows an example of an asset management dashboard for viewing asset information based on labels in an illustrative embodiment.

FIG. 5 shows an example of an asset management dashboard for selecting and performing tasks based on labels in an illustrative embodiment.

FIG. 6 shows a flow diagram of a process for characterizing computer infrastructure using machine learning techniques in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Conventional techniques for characterizing computer infrastructure generally do not provide functionality that allows users, such as system administrators, to efficiently label or manage assets and/or inventory. Rather, system administrators often are required to manually group and tag assets in various ways to help monitor or manage the assets. Applications that provide tagging functionality require significant manual user action to generate and manage tags. Such applications generally do not expose this information at a high level in the information architecture and do not enable administrators to perform a broad range of actions based on assigned tags.

The term “label” as used herein is intended to be broadly construed so as to encompass, for example, information characterizing one or more computer infrastructure elements or portions thereof, whether or not in printed form. Machine learning models can be trained to output one or more labels as predictions for one or more inputs (e.g., corresponding to features of a dataset).

The term “computer infrastructure element” as used herein is intended to be broadly construed so as to encompass, for example, computer infrastructure components, information technology (IT) infrastructure, IT infrastructure elements, IT infrastructure components, hardware components, software components and/or other computer assets, including compute, storage, and/or networking devices, printers, virtual machines, and software applications, as well as various combinations of such entities.

Some consumer tools exist (e.g., recommendation engines) that create recommendations for existing objects, such as movies or shows. However, these techniques are not well suited for managing computer assets, which can benefit from new tags being created. In other words, it is desirable to generate recommendations of objects (e.g., labels for assets) that do not currently exist. One or more embodiments described herein provide machine learning techniques that can improve the tagging and management of computer assets (e.g., physical and/or logical assets).

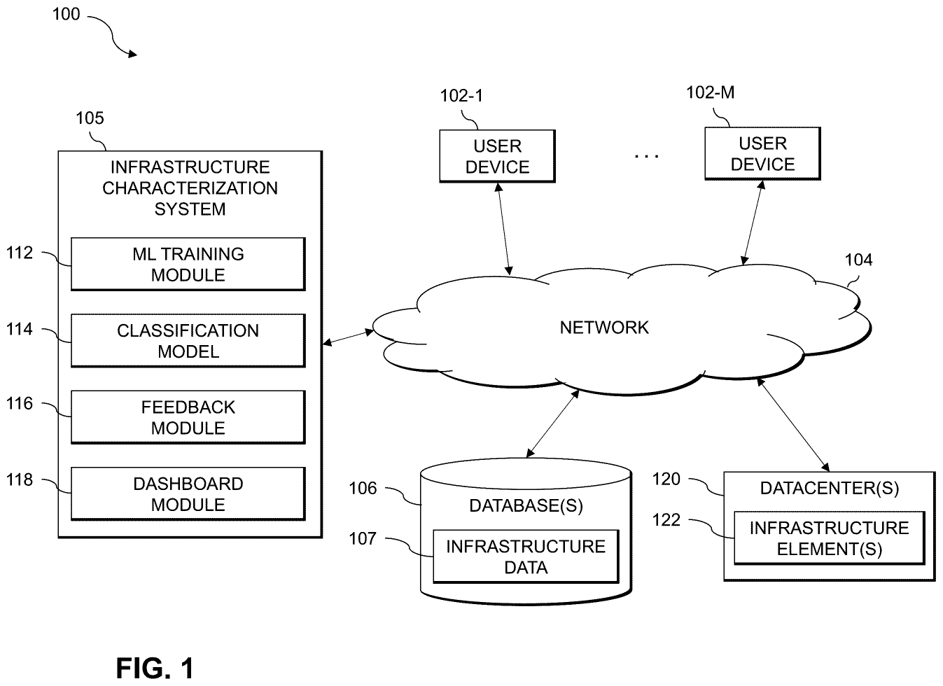

FIG. 1 shows a computer network (also referred to herein as an information processing system) 100 configured for characterizing computer infrastructure using machine learning techniques in accordance with an illustrative embodiment. The computer network 100 comprises a plurality of user devices 102-1, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an infrastructure characterization system 105.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.”

Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the infrastructure characterization system 105 can have at least one associated database 106 configured to store infrastructure data 107 pertaining to, for example, configuration data and/or analytic data associated with one or more computer infrastructure elements. In at least some embodiments, the computer infrastructure elements optionally can correspond to one or more infrastructure elements 122 associated with one or more datacenters 120, for example.

An example database 106, such as depicted in the present embodiment, can be implemented using one or more storage systems associated with the infrastructure characterization system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the infrastructure characterization system 105 are one or more input-output devices, which illustratively comprise keyboards, displays or other types of input-output devices in any combination. Such input-output devices can be used, for example, to support one or more user interfaces to the infrastructure characterization system 105, as well as to support communication between infrastructure characterization system 105 and other related systems and devices not explicitly shown.

Additionally, the infrastructure characterization system 105 in the FIG. 1 embodiment is assumed to be implemented using at least one processing device. Each such processing device generally comprises at least one processor and an associated memory, and implements one or more functional modules for controlling certain features of the infrastructure characterization system 105.

More particularly, the infrastructure characterization system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including flash drives and solid-state drives (SSDs), and should therefore not be viewed as limited in any way to spinning magnetic media.

The network interface allows the infrastructure characterization system 105 to communicate over the network 104 with the user devices 102, and illustratively comprises one or more conventional transceivers.

The infrastructure characterization system 105 further comprises a ML (machine learning) training module 112, a classification model 114, a feedback module 116, and a dashboard module 118.

Generally, the ML training module 112 trains the classification model 114 based on a set of training data associated with infrastructure data 107 and analytics data collected from user interactions (e.g., corresponding to user devices 102) with computer infrastructure elements. In at least some embodiments, the infrastructure data 107 for a given computer infrastructure element can comprise one or more identifiers (e.g., one or more serial numbers or and/or one or more computer infrastructure element names) of the computer infrastructure elements; a product type; a deployment type; a geographic location; a site identifier; a site name; username, roles, and/or permissions associated with the computer infrastructure element; existing labels; and/or other types of configuration data, such as configuration data related to data protection policies and/or features of the computer infrastructure element that have been enabled or disabled. The classification model 114 is trained to generate recommendations of labels without needing a manual designation by a system administrator, for example.

The feedback module 116 is configured to collect feedback regarding one or more of the recommendations generated by the classification model 114. For example, the feedback can include a user input that accepts a given recommendation, rejects a given recommendation, or edits a given recommendation before accepting the given recommendation. In some embodiments, the feedback module 116 is also configured to collect analytics data associated with at least some of the computer infrastructure elements. For example, the analytics data may include collecting a number of interactions and/or an amount of time of interactions of a given user (e.g., a system administrator) with a given computer infrastructure element and/or a page associated with the computer infrastructure element (e.g., a configuration and/or dashboard page). The analytics data may alternatively or additionally comprise selection of physical and/or virtual systems by the user, one or more management actions taken with respect to the one or more of the computer infrastructure elements, and user interface and/or user profile information. Such information can be provided to the ML training module, which can then retrain the classification model 114 to consider such information.

The dashboard module 118 is configured to generate notifications of recommendations output by the classification model 114, and provide a user interface for navigating, viewing, and/or performing active management tasks based on labels assigned to the computer infrastructure elements, as described in more detail elsewhere herein.

It is to be appreciated that this particular arrangement of elements 112, 114, 116, and 118 illustrated in the infrastructure characterization system 105 of the FIG. 1 embodiment is presented by way of example only, and alternative arrangements can be used in other embodiments. For example, the functionality associated with the elements 112, 114, 116, and 118 in other embodiments can be combined into a single module, or separated across a larger number of modules. As another example, multiple distinct processors can be used to implement different ones of the elements 112, 114, 116, and 118 or portions thereof.

At least portions of elements 112, 114, 116, and 118 may be implemented at least in part in the form of software that is stored in memory and executed by a processor.

It is to be understood that the particular set of elements shown in FIG. 1 for infrastructure characterization system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the infrastructure characterization system 105 and database(s) 106 can be on and/or part of the same processing platform.

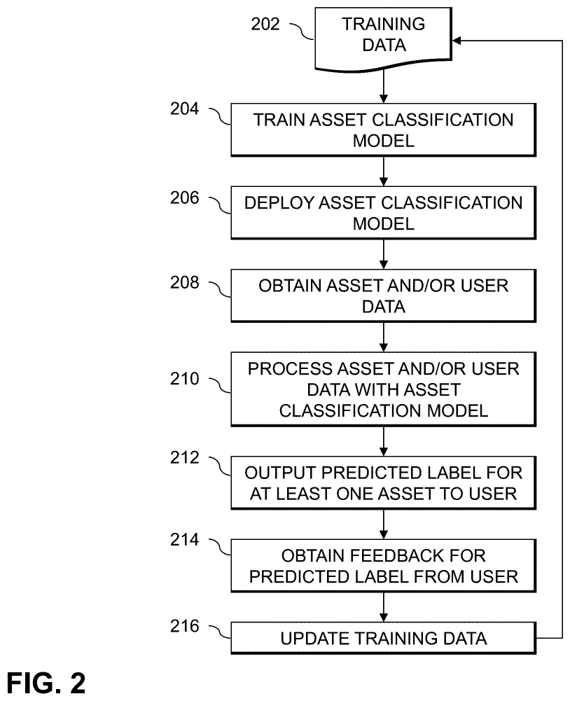

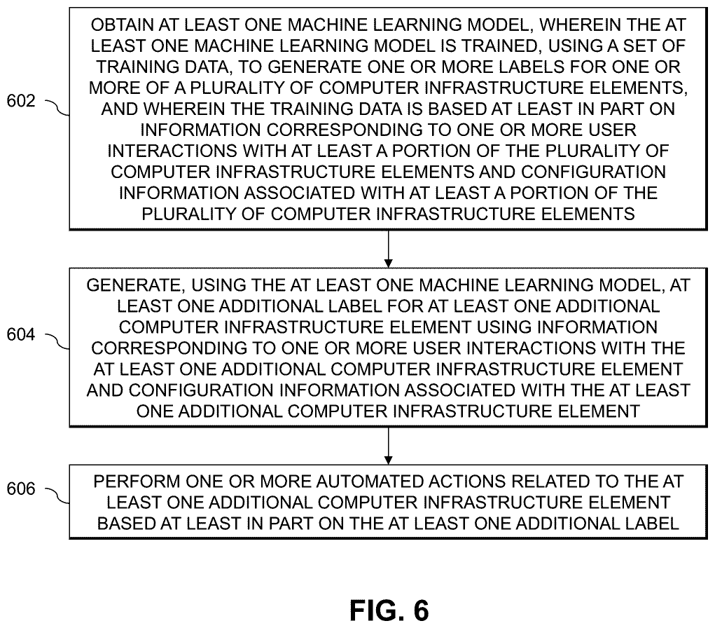

An exemplary process utilizing elements 112, 114, 116, and 118 of an example infrastructure characterization system 105 in computer network 100 will be described in more detail with reference to, for example, the flow diagrams of FIGS. 2 and 6.

FIG. 2 shows a flow diagram for training a machine learning model in an illustrative embodiment. Training data 202 is used to initially train an asset classification model (e.g., corresponding to classification model 114) at step 204. Step 204 can initially be performed in some embodiments as part of an “offline” process, where the training data is created based on historical data associated with one or more computer assets. For example, training data 202 can correspond to known attributes of one or more assets and/or one or more datacenters including, for example, system name(s), location(s), site identifier(s), customer type(s), and/or customer segment(s) as feature variables. The training data 202 can also include a set of existing asset tags as labels. Accordingly, step 204 can include performing a supervised learning process to train the asset classification model, where the supervised learning process estimates the tags based on the feature variables.

In at least some embodiments, each variable in the dataset can be converted into a string format (e.g., a word or token). In such embodiments, the asset classification model can comprise a natural language processing (NLP) model that can generate summary words and/or summary titles, which can be output as labels, for example. As a non-limiting example, the asset classification model can comprise a long short-term memory model (LSTM) model. Generally, an LSTM model is a type of recurrent neural network (RNN) that is capable of learning long-term (e.g., temporal) dependencies. LSTM models can process an entire sequence of data using feedback connections. An LSTM model can include a plurality of LSTM units, where each LSTM unit comprises a cell state and three logical gates (an input gate, an output gate, and a forget gate). The forget gate decides which information from the previous cell state should be forgotten (e.g., by applying a sigmoid function). The input gate controls the information flow to the current cell state, and the output gate decides which information should be passed on to the next hidden state. It is to be appreciated that other machine learning models can be used in other embodiments, including other RNN-based models and transformer-based models (e.g., a Bidirectional Encoder Representations from Transformers (BERT) model).

Step 206 includes deploying the classification model. For example, the asset classification model can be deployed at one or more datacenters.

Step 208 includes obtaining asset and/or user data (e.g., analytics data) associated with one or more assets, and step 210 includes processing the asset and/or user data with the asset classification model.

Step 212 includes outputting to a user (e.g., a system administrator) a predicted label for at least one asset.

Step 214 includes obtaining feedback for the predicted label from the user.

Step 216 includes updating the training data 202 based at least in part on the feedback. The asset classification model can then be retrained at step 204 using the updated training data 202. In some embodiments, the asset classification model can be retrained on a periodic basis (e.g., daily, weekly, etc.) and/or in response to one or more criteria being satisfied (e.g., a threshold number of new labels being assigned to assets, a threshold number of changes to existing assets and/or existing labels, and/or a threshold number of new assets being added or removed). Accordingly, the asset classification model can be continuously improved over time. This continuous learning process helps avoid tags being misapplied or not applied where relevant, and also removes the impact of user typographical errors.

The asset classification model also can personalize the recommendations provided for a given user by retraining the asset classification model based on the user accepting one or more recommendations or if the user provided alternate tag names, for example.

It is to be appreciated that the training datasets used for training and re-training the asset classification model, in some embodiments, can be edited or expanded to generate more tagging recommendations based on, for example, user-generated labels, edits to recommended labels, language of labels, and/or analytics data collected from one or more users.

By way of example, consider a scenario in which a user has existing assets categorized into a particular tag (say, “tag_x”), and the general properties of all assets under that tag are storage systems with a particular range of storage capacity. When a new storage system with capacity within this same range is on-boarded or discovered, the asset classification model can automatically suggest the label “tag_x” based on the generalized properties.

As another example, consider an asset provider that ships or installs an asset, and that asset provider maintains information on where the asset was shipped or installed. The asset classification model can automatically recommend labels based on this location information so as to group and tag the assets together (e.g., all assets shipped to New York can automatically be tagged with a “New York” label).

In some embodiments, the asset classification model can also leverage user-specific (or team-specific) naming conventions as part of the continuous learning process to make asset tagging recommendations. The asset classification model can be trained to consider and recommend tags based on a user's abbreviation for a particular term. For example, the terms “poweredge”, “PowerEdge”, and “PE” can all be synonymous with a brand of servers, and the asset classification model can consider such variations when generating recommended labels.

In at least some embodiments, the infrastructure characterization system 105 can also inform a user if one or more assets are not being “utilized” based on analytical datasets (e.g., a particular asset has not been accessed for at least a threshold amount of time), and can recommend tags for such assets, such as “archive”, or an end-of-life tag (e.g., “EOL”).

Also, in some embodiments, if multiple users are monitoring and/or managing a same set of assets, then the infrastructure characterization system 105 can share tagging recommendations across the multiple users (e.g., associated with a team), thereby improving consistency of labels and reducing redundant labels, for example.

Although the machine learning model is described with respect to a natural language format, it is to be appreciated that such techniques are also applicable to generating personalized tags to group assets using images, emojis, shapes, symbols (e.g., QR codes), and/or multiple different languages.

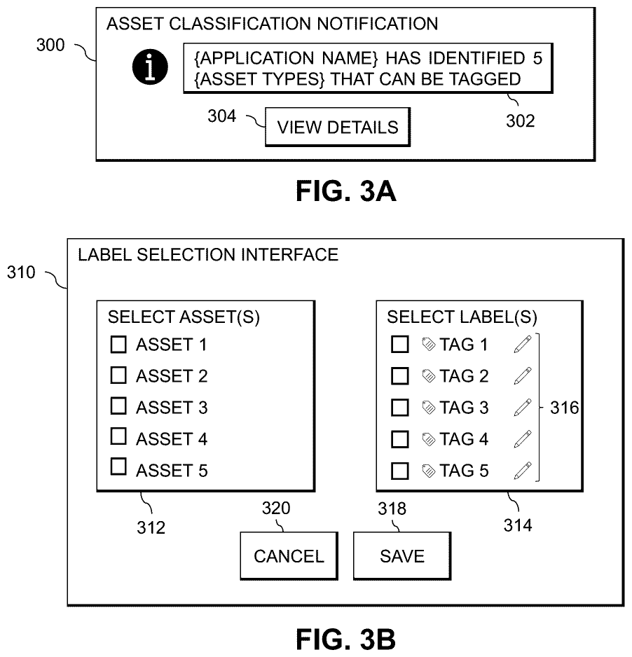

FIG. 3A shows an example of a classification notification 300 in an illustrative embodiment. In this example, it is assumed that the classification notification 300 is generated in response to one or more classifications being generated (e.g., by classification model 114). The classification notification 300 can be output to a user interface (e.g., associated with one or more of the user devices 102). In this example, the classification notification 300 includes a field 302 indicating that candidate labels have been generated for five asset types. The classification notification 300 also includes a UI element 304, which if selected, can cause a label selection interface to be displayed to the user, such as the label selection interface of FIG. 3B.

According to at least one embodiment, a classification notification (e.g., classification notification 300) can be displayed based on analytic datasets corresponding to a given user. By way of example, according to one embodiment, an algorithm can be applied to the analytic datasets to determine when to display a notification. A non-limiting example of such an algorithm includes determining, within a certain time-period window, that a user has: (i) selected an asset at least N times; (ii) spent at least T minutes viewing a page of a given asset, and/or (iii) performed at least M action(s) with the asset (e.g., action to run a pre-check, generate a report, and/or launch a management URL). Other algorithms are also possible, including algorithms for generating tags to ignore one or more assets, for example.

FIG. 3B shows an example of a label selection interface 310 in an illustrative embodiment. The label selection interface 310 includes an asset selection component 312, which lists the names of five exemplary assets (asset 1-asset 5) and includes selection boxes for each of the assets. The label selection interface 310 also includes a label selection component 314, which lists labels (tag 1-tag 5). The label selection component 314 also includes a set of selection boxes for each of the labels, and option buttons 316 to edit each of the labels. The label selection interface 310 also includes UI (user interface) element 318 for saving changes and a UI element 320 for canceling the selection process. By way of example, if a user (e.g., a system administrator) selects the selection boxes corresponding to asset 1 and tag 1, and then selects the save UI element 318, then tag 1 can be assigned to asset 1. It is to be appreciated that the example shown in FIG. 3B is not intended to be limiting, and other types and/or arrangements of user interfaces can also be used. As another example, the label selection component 314 may include additional UI elements for rejecting one or more of the listed tags.

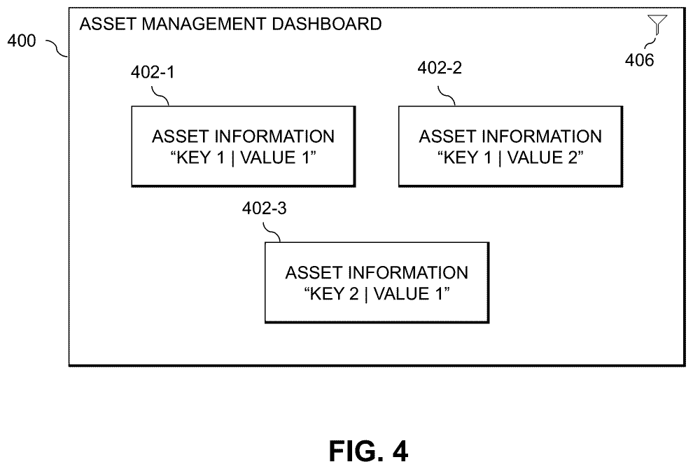

FIG. 4 shows an example of an asset management dashboard 400 for viewing asset information based on labels in an illustrative embodiment. The asset management dashboard 400 can display asset information for multiple tags. In the FIG. 4 example, the asset management dashboard 400 shows three sets of asset information 402-1, 402-2, 402-3 corresponding to labels “key 1|value 1”, “key 1|value 2”, and “key 2|value 1”, respectively. As an example, the labels associated with asset information 402-1 and 402-2 could correspond to locations of assets, and the label associated with asset information 402-3 could correspond to a type of asset. The asset information 402-1, 402-2, 402-3 can indicate a number of assets associated with each tag as well as other information, such as health scores computed for such assets (e.g., based on an availability of a given asset or performance metrics). The asset management dashboard 400 also includes a filter button 406 for filtering and/or selecting labels and/or information to be displayed on the asset management dashboard 400. At least some of the tags can be generated automatically, thus allowing the user to easily monitor information for particular sets of assets based on the tags.

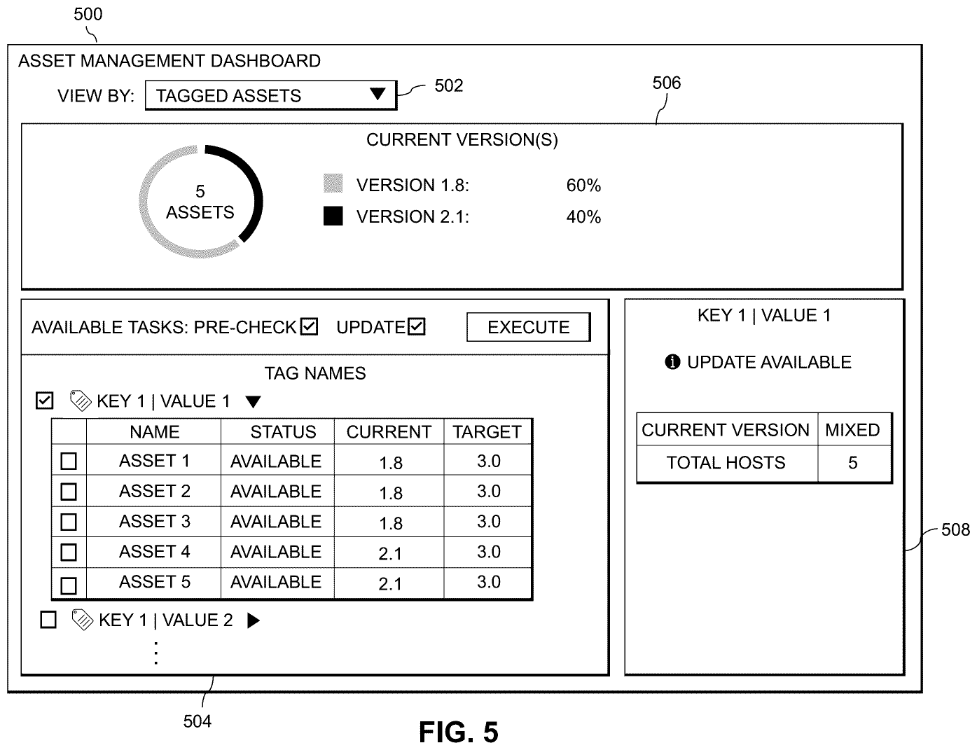

FIG. 5 shows an example of an asset management dashboard 500 for selecting and performing tasks based on labels in an illustrative embodiment. In this example, it is assumed that the asset management dashboard 500 is configured to perform a pre-check operation and/or an update operation. More specifically, a user has selected to view “tagged assets” in a dropdown menu 502 and selected the selection box corresponding to label “key 1|value 1” in the tag names component 504 of the asset management dashboard 500. It is to be appreciated that one or more additional tag names can also be shown and selected in the tag names component 504. In some embodiments, the dropdown menu may include other options, such as an option to view untagged assets.

In response to the user selection, the asset management dashboard 500 can populate the current version(s) field 506 with relevant information (which in this example, is an overview of version information related to the corresponding assets). Notification field 508 can provide additional information related to the components, such as a notification that an update is available, and possibly further information related to the update notification (e.g., version information, changelogs, etc.). The asset management dashboard 500 can alternatively or additionally display other information associated with the assets, including location information of assets, types of assets, status information, health score information (e.g., based on an availability of a given asset and/or performance metrics), and/or types of deployment environments of assets (e.g., production environment, testing environment, development environment, etc.).

The tag names component 504 also includes additional information for each asset with the selected tag (e.g., asset name, status, current version, and target version), and selection boxes for selecting the available tasks, as well as a button for executing the selected tasks. Accordingly, the asset management dashboard 500 provides an intuitive way to proactively manage computer assets based on automatically generated labels assigned to the assets, for example.

FIG. 6 is a flow diagram of a process for characterizing computer infrastructure using machine learning techniques in an illustrative embodiment. It is to be understood that this particular process is only an example, and additional or alternative processes can be carried out in other embodiments.

In this embodiment, the process includes steps 602 through 606. These steps are assumed to be performed by the infrastructure characterization system 105 utilizing its elements 112, 114, 116, and 118.

Step 602 includes obtaining at least one machine learning model, wherein the at least one machine learning model is trained, using a set of training data, to generate one or more labels for one or more of a plurality of computer infrastructure elements, and wherein the training data is based at least in part on information corresponding to one or more user interactions with at least a portion of the plurality of computer infrastructure elements and configuration information associated with at least a portion of the plurality of computer infrastructure elements.

Step 604 includes generating, using the at least one machine learning model, at least one additional label for at least one additional computer infrastructure element using information corresponding to one or more user interactions with the at least one additional computer infrastructure element and configuration information associated with the at least one additional computer infrastructure element. For example, the at least one additional computer infrastructure element may be a new computer infrastructure element and/or an existing one of the plurality of computer infrastructure elements that is not assigned a label. In some embodiments, the at least one machine learning model may process data corresponding to the user interactions and the configuration information (and possibly other data, such as one or more serial numbers) associated with the additional computer infrastructure element. The data, in some embodiments, is provided as a set of word vectors, which is processed by the at least one machine learning model to generate the at least one additional label.

Step 606 includes performing one or more automated actions related to the at least one additional computer infrastructure element based at least in part on the at least one additional label.

The set of training data may include a set of existing labels associated with one or more of the plurality of computer infrastructure elements, and the at least one additional label may be different than each of the existing labels. The machine learning model may be trained at least in part by: generating a set of words by transforming at least one of: (i) one or more portions of the information corresponding to the one or more user interactions into a natural language format and (ii) one or more portions of the configuration information into a natural language format; and processing the set of words to generate a corresponding set of embeddings, wherein each embedding encodes one or more features of a given word in the set of words. The at least one machine learning model may include at least one of: a transformer-based model, a long short-term memory model, and a recurrent neural network model. The process may further include the steps of: outputting the at least one additional label to a user; and assigning the at least one additional label to the at least one additional computer infrastructure element in response to one or more inputs provided by the user. The one or more inputs may include one or more edits to the additional label, and the assigning may include: updating the at least one additional label based on the one or more edits; and assigning the updated at least one additional label to the at least one additional computer infrastructure element. The outputting may be performed in response to detecting, within a particular time period, at least one of: a threshold number of interactions with the additional computer infrastructure element by the user; a threshold number of times the user interacted with the additional computer infrastructure element; and a threshold number of actions performed by the user related to the additional computer infrastructure element. The at least one machine learning model may be retrained in response to at least one of a change to at least one label that is currently assigned to a given one of the computer infrastructure elements and a new label being assigned to at least one of the plurality of computer infrastructure elements. The one or more automated actions related to the at least one additional computer infrastructure element may include at least one of: providing at least one notification of the at least one additional label to a user; initiating an update operation of one or more of the at least one additional computer infrastructure element; performing a restore operation of one or more of the at least one additional computer infrastructure element; and performing a reboot operation of one or more of the at least one additional computer infrastructure element. The plurality of computer infrastructure elements may correspond to at least one datacenter and may include at least one of: a hardware infrastructure element deployed at the at least one datacenter; a software infrastructure element deployed at least in part at the at least one datacenter. The process may further include the steps of: providing a dashboard related to the plurality of computer infrastructure elements, where the dashboard is configured to at least one of: display computer infrastructure element information corresponding to one or more of the plurality of computer infrastructure elements based at least in part on one or more labels generated using the at least one machine learning model; and initiate one or more tasks corresponding to one or more of the plurality of computer infrastructure elements based at least in part on one or more labels generated using the at least one machine learning model. The information corresponding to the one or more user interactions may include at least one of: a type of interaction with a given one of the plurality of computer infrastructure elements; a number of interactions with a given one of the plurality of computer infrastructure elements; an amount of time interacting with a given one of the plurality of computer infrastructure elements; and one or more preferences associated with at least one user performing the one or more user interactions. The configuration information associated with a given one of the plurality of computer infrastructure elements may include at least one of: an identifier for the given computer infrastructure element; a type of the given computer infrastructure element; a type of deployment of the given computer infrastructure element; a geographical location of the given computer infrastructure element; and at least one existing label assigned to the given computer infrastructure element.

Accordingly, the particular processing operations and other functionality described in conjunction with the flow diagram of FIG. 6 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to significantly improve the efficiency of managing computer infrastructure element. These and other embodiments can effectively overcome problems associated with existing computer infrastructure management techniques that require system administrators to manually assign and group computer infrastructure elements. Additionally, at least some embodiments can provide improved user interfaces for monitoring and managing computer infrastructure elements using such labels.

Illustrative embodiments can provide significant advantages relative to conventional computer infrastructure management techniques. For example, technical problems associated with monitoring and actively managing computer infrastructure elements are mitigated in one or more embodiments by implementing a machine learning framework that can generate labels based on information associated with user interactions and configuration data corresponding to such infrastructure elements, and then performing automated actions to actively manage the computer infrastructure elements based on the labels.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

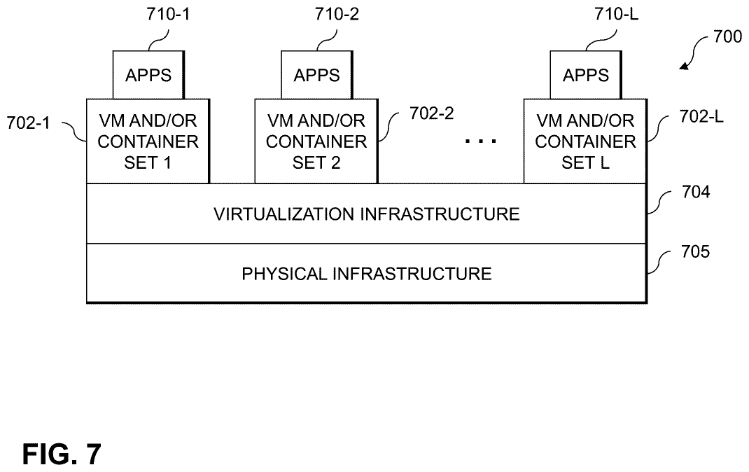

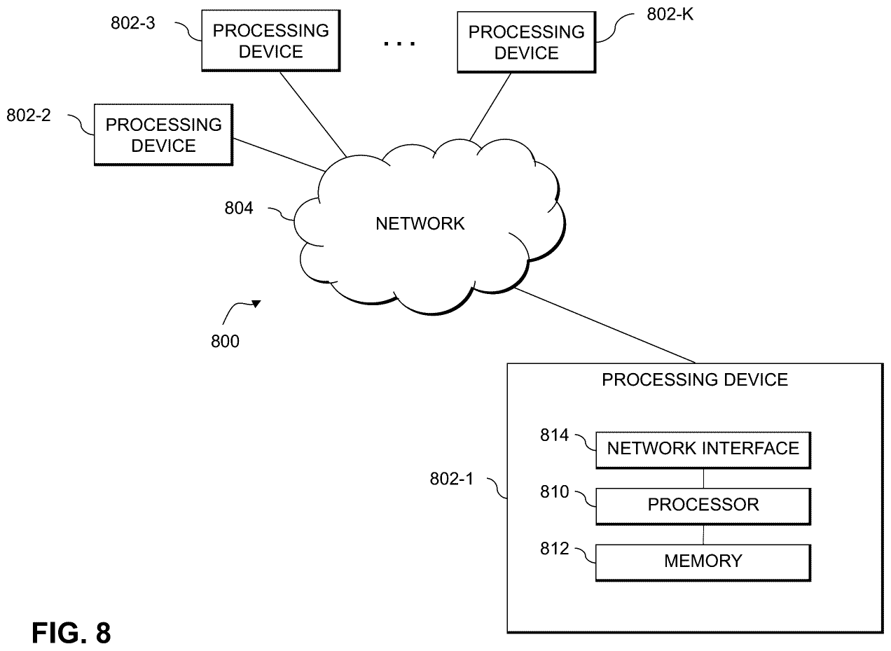

Illustrative embodiments of processing platforms will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that are utilized to implement at least a portion of the information processing system 100. The cloud infrastructure 700 comprises multiple virtual machines (VMs) and/or container sets 702-1, 702-2, 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 comprise respective VMs, respective sets of one or more containers, or respective sets of one or more containers running in VMs. In some implementations of the FIG. 7 embodiment, the VMs/container sets 702 comprise respective VMs implemented using virtualization infrastructure 704 that comprises at least one hypervisor.

A hypervisor platform may be used to implement a hypervisor within the virtualization infrastructure 704, wherein the hypervisor platform has an associated virtual infrastructure management system. The underlying physical machines comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 802-1 in the processing platform 800 comprises a processor 810 coupled to a memory 812.

The processor 810 comprises a microprocessor, a microcontroller, an ASIC, an FPGA or other type of processing circuitry, as well as portions or combinations of such circuitry elements.

The memory 812 comprises RAM, ROM or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining at least one machine learning model, wherein the at least one machine learning model is trained, using a set of training data, to generate one or more labels for one or more of a plurality of computer infrastructure elements, and wherein the training data is based at least in part on information corresponding to one or more user interactions with at least a portion of the plurality of computer infrastructure elements and configuration information associated with at least a portion of the plurality of computer infrastructure elements;
generating, using the at least one machine learning model, at least one additional label for at least one additional computer infrastructure element using information corresponding to one or more user interactions with the at least one additional computer infrastructure element and configuration information associated with the at least one additional computer infrastructure element; and
performing one or more automated actions related to the at least one additional computer infrastructure element based at least in part on the at least one additional label;
wherein the method is performed by at least one processing device comprising a processor coupled to a memory.

2. The computer-implemented method of claim 1, wherein the set of training data comprises a set of existing labels associated with one or more of the plurality of computer infrastructure elements, and wherein the at least one additional label is different than each of the existing labels.

3. The computer-implemented method of claim 1, wherein the machine learning model is trained at least in part by:
generating a set of words by transforming at least one of: (i) one or more portions of the information corresponding to the one or more user interactions into a natural language format and (ii) one or more portions of the configuration information into a natural language format; and
processing the set of words to generate a corresponding set of embeddings, wherein each embedding encodes one or more features of a given word in the set of words.

4. The computer-implemented method of claim 1, wherein the at least one machine learning model comprises at least one of: a transformer-based model, a long short-term memory model, and a recurrent neural network model.

5. The computer-implemented method of claim 1, comprising:
outputting the at least one additional label to a user; and
assigning the at least one additional label to the at least one additional computer infrastructure element in response to one or more inputs provided by the user.

6. The computer-implemented method of claim 5, wherein the one or more inputs comprise one or more edits to the additional label, and wherein the assigning comprises:
updating the at least one additional label based on the one or more edits; and
assigning the updated at least one additional label to the at least one additional computer infrastructure element.

7. The computer-implemented method of claim 5, wherein the outputting is performed in response to detecting, within a particular time period, at least one of:
a threshold number of interactions with the additional computer infrastructure element by the user;
a threshold number of times the user interacted with the additional computer infrastructure element; and
a threshold number of actions performed by the user related to the additional computer infrastructure element.

8. The computer-implemented method of claim 1, wherein the at least one machine learning model is retrained in response to at least one of a change to at least one label that is currently assigned to a given one of the computer infrastructure elements and a new label being assigned to at least one of the plurality of computer infrastructure elements.

9. The computer-implemented method of claim 1, wherein the one or more automated actions related to the at least one additional computer infrastructure element comprise at least one of:
providing at least one notification of the at least one additional label to a user;
initiating an update operation of one or more of the at least one additional computer infrastructure element;
performing a restore operation of one or more of the at least one additional computer infrastructure element; and
performing a reboot operation of one or more of the at least one additional computer infrastructure element.

10. The computer-implemented method of claim 1, wherein the plurality of computer infrastructure elements corresponds to at least one datacenter and comprises at least one of:
a hardware infrastructure element deployed at the at least one datacenter;
a software infrastructure element deployed at least in part at the at least one datacenter.

11. The computer-implemented method of claim 1, further comprising:
providing a dashboard related to the plurality of computer infrastructure elements, wherein the dashboard is configured to at least one of:
display computer infrastructure element information corresponding to one or more of the plurality of computer infrastructure elements based at least in part on one or more labels generated using the at least one machine learning model; and
initiate one or more tasks corresponding to one or more of the plurality of computer infrastructure elements based at least in part on one or more labels generated using the at least one machine learning model.

12. The computer-implemented method of claim 1, wherein the information corresponding to the one or more user interactions comprises at least one of:
a type of interaction with a given one of the plurality of computer infrastructure elements;
a number of interactions with a given one of the plurality of computer infrastructure elements;
an amount of time interacting with a given one of the plurality of computer infrastructure elements; and
one or more preferences associated with at least one user performing the one or more user interactions.

13. The computer-implemented method of claim 1, wherein the configuration information associated with a given one of the plurality of computer infrastructure elements comprises at least one of:
an identifier for the given computer infrastructure element;
a type of the given computer infrastructure element;
a type of deployment of the given computer infrastructure element;
a geographical location of the given computer infrastructure element; and
at least one existing label assigned to the given computer infrastructure element.

14. A non-transitory processor-readable storage medium having stored therein program code of one or more software programs, wherein the program code when executed by at least one processing device causes the at least one processing device:
to obtain at least one machine learning model, wherein the at least one machine learning model is trained, using a set of training data, to generate one or more labels for one or more of a plurality of computer infrastructure elements, and wherein the training data is based at least in part on information corresponding to one or more user interactions with at least a portion of the plurality of computer infrastructure elements and configuration information associated with at least a portion of the plurality of computer infrastructure elements;
to generate, using the at least one machine learning model, at least one additional label for at least one additional computer infrastructure element using information corresponding to one or more user interactions with the at least one additional computer infrastructure element and configuration information associated with the at least one additional computer infrastructure element; and
to perform one or more automated actions related to the at least one additional computer infrastructure element based at least in part on the at least one additional label.

15. The non-transitory processor-readable storage medium of claim 14, wherein the set of training data comprises a set of existing labels associated with one or more of the plurality of computer infrastructure elements, and wherein the at least one additional label is different than each of the existing labels.

16. The non-transitory processor-readable storage medium of claim 14, wherein the machine learning model is trained at least in part by:
generating a set of words by transforming at least one of: (i) one or more portions of the information corresponding to the one or more user interactions into a natural language format and (ii) one or more portions of the configuration information into a natural language format; and
processing the set of words to generate a corresponding set of embeddings, wherein each embedding encodes one or more features of a given word in the set of words.

17. The non-transitory processor-readable storage medium of claim 14, wherein the at least one machine learning model comprises at least one of: a transformer-based model, a long short-term memory model, and a recurrent neural network model.

18. An apparatus comprising:
at least one processing device comprising a processor coupled to a memory;
the at least one processing device being configured:
to obtain at least one machine learning model, wherein the at least one machine learning model is trained, using a set of training data, to generate one or more labels for one or more of a plurality of computer infrastructure elements, and wherein the training data is based at least in part on information corresponding to one or more user interactions with at least a portion of the plurality of computer infrastructure elements and configuration information associated with at least a portion of the plurality of computer infrastructure elements;
to generate, using the at least one machine learning model, at least one additional label for at least one additional computer infrastructure element using information corresponding to one or more user interactions with the at least one additional computer infrastructure element and configuration information associated with the at least one additional computer infrastructure element; and
to perform one or more automated actions related to the at least one additional computer infrastructure element based at least in part on the at least one additional label.

19. The apparatus of claim 18, wherein the set of training data comprises a set of existing labels associated with one or more of the plurality of computer infrastructure elements, and wherein the at least one additional label is different than each of the existing labels.

20. The apparatus of claim 18, wherein the machine learning model is trained at least in part by:
generating a set of words by transforming at least one of: (i) one or more portions of the information corresponding to the one or more user interactions into a natural language format and (ii) one or more portions of the configuration information into a natural language format; and
processing the set of words to generate a corresponding set of embeddings, wherein each embedding encodes one or more features of a given word in the set of words.
